(19) United States
(12) Patent Application Publication
(10) Pub. No.: US 2024/0340789 A1
(43) Pub. Date: Oct. 10, 2024

(54) R-TWT BASED MULTI-AP COORDINATION

(71) Applicant: Samsung Electronics Co., Ltd., Suwon-si (KR)

(72) Inventors: Rubayet Shafin, Allen, TX (US); Boon Loong Ng, Plano, TX (US); Yue Qi, Plano, TX (US); Peshal Nayak, Plano, TX (US); Vishnu Vardhan Ratnam, Plano, TX (US); Elliot Jen, Taipei City (TW)

(21) Appl. No.: 18/603,063

(22) Filed: Mar. 12, 2024

Related U.S. Application Data
(60) Provisional application No. 63/458,038, filed on Apr. 7, 2023.

(51) Int. Cl. H04W 52/02; H04L 5/00; H04W 28/18; H04W 84/12

(52) U.S. Cl. CPC H04W 52/0216; H04L 5/0035; H04W 28/18; H04W 84/12

(57) ABSTRACT

A wireless communication network includes a first access point (AP) device, the first AP device may receive information related to a target wake time (TWT) schedule and operating channel information from a second AP, wherein the TWT schedule is established on a second channel by the second AP in a second basic service set (BSS), and transmit, during a TWT service period (SP) of the TWT schedule, data on a first channel in a first BSS, where the first channel and the second channel are different.

### CROSS-REFERENCE TO RELATED APPLICATIONS

This application claims the benefit of priority from U.S. Provisional Application No. 63/458,038, entitled “HANDLING FAIRNESS ISSUE FOR R-TWT BASED MAP COORDINATION,” filed Apr. 7, 2023, which is incorporated herein by reference in its entirety.

### TECHNICAL FIELD

This disclosure relates generally to a wireless communication system, and more particularly to, for example, but not limited to, restricted target-wake-time (R-TWT) based multi-access point (AP) coordination in wireless communication systems.

### BACKGROUND

Wireless local area network (WLAN) technology has evolved toward increasing data rates and continues its growth in various markets such as home, enterprise and hotspots over the years since the late 1990s. WLAN allows devices to access the internet in the 2.4 GHZ, 5 GHZ, 6 GHz or 60 GHz frequency bands. WLANs are based on the Institute of Electrical and Electronic Engineers (IEEE) 802.11 standards. IEEE 802.11 family of standards aims to increase speed and reliability and to extend the operating range of wireless networks.

WLAN devices are increasingly required to support a variety of delay-sensitive applications or real-time applications such as augmented reality (AR), robotics, artificial intelligence (AI), cloud computing, and unmanned vehicles. To implement extremely low latency and extremely high throughput required by such applications, multi-link operation (MLO) has been suggested for the WLAN. The WLAN is formed within a limited area such as a home, school, apartment, or office building by WLAN devices. Each WLAN device may have one or more stations (STAs) such as the access point (AP) STA and the non-access-point (non-AP) STA.

The MLO may enable a non-AP multi-link device (MLD) to set up multiple links with an AP MLD. Each of multiple links may enable channel access and frame exchanges between the non-AP MLD and the AP MLD independently, which may reduce latency and increase throughput.

The description set forth in the background section should not be assumed to be prior art merely because it is set forth in the background section. The background section may describe aspects or embodiments of the present disclosure.

### SUMMARY

One aspect of the present disclosure provides a first access point (AP) in a wireless network. The first AP comprises a memory and a processor coupled to the memory. The processor is configured to receive information related to a target wake time (TWT) schedule and operating channel information from a second AP, where the TWT schedule is established on a second channel by the second AP in a second basic service set (BSS). The processor is configured to transmit, during a TWT service period (SP) of the TWT schedule, data on a first channel in a first BSS, wherein the first channel and the second channel are different.

In some embodiments, the processor is further configured to select the first channel to transmit data based on the operating channel information.

In some embodiments, the operating channel information indicates the first channel as an operating channel that the first AP is allowed to use to transmit data during the TWT SP of the TWT schedule.

In some embodiments, the processor is configured to continue a transmit opportunity (TXOP) established in the first BSS during the TWT SP of the TWT schedule.

In some embodiments, the second channel is a primary channel and the first channel is a secondary channel.

In some embodiments, the first AP ensures that a first transmit opportunity (TXOP) ends in the first BSS before a start time of a first TWT SP of the TWT schedule and ensures that a second TXOP continues in the first BSS during a second TWT SP of the TWT schedule.

In some embodiments, the processor is configured to transmit a frame to the second AP that notifies the second AP that the first AP intends to end a transmit opportunity (TXOP) in the first BSS before a start time of a TWT SP of the TWT schedule for a first set of TWT SPs of the TWT schedule and the first AP intends to continue a TXOP for a second set of TWT SPs of the TWT schedule.

In some embodiments, the first AP and the second AP are members of a TWT coordinating multi-AP set.

In some embodiments, the processor is configured to negotiate with the second AP to participate in TWT multi-AP coordination, wherein the first AP is a shared AP and the second AP is a sharing AP.

One aspect of the present disclosure provides a first access point (AP) in a wireless network. The first AP comprises a memory and a processor coupled to the memory. The processor is configured to transmit information related to a target wake time (TWT) schedule and operating channel information to a second AP, wherein the TWT schedule is established on a first channel by the first AP in a first basic service set (BSS). The processor is configured to transmit, during a TWT service period (SP) of the TWT schedule, data on the first channel in the first BSS, wherein the second AP transmits data on a second channel during the TWT SP of the TWT schedule.

In some embodiments, the operating channel information indicates the second channel as an operating channel that the second AP is allowed to use to transmit data during the TWT SP of the TWT schedule.

In some embodiments, the first channel is a primary channel and the second channel is a secondary channel.

In some embodiments, the first AP and the second AP are members of a TWT coordinating AP set.

In some embodiments, the processor is configured to negotiate with the second AP for TWT multi-AP coordination, wherein the first AP is a sharing AP and the second AP is a shared AP.

One aspect of the present disclosure provides a computer-implemented method for facilitating communication in a wireless network. The method comprises receiving information related to a target wake time (TWT) schedule and operating channel information from a second AP, wherein the TWT schedule is established on a second channel by the second AP in a second basic service set (BSS). The method comprises transmitting, during a TWT service period (SP) of the TWT schedule, data on a first channel in a first BSS, wherein the first channel and the second channel are different.

In some embodiments, the method further comprises selecting the first channel to transmit data based on the operating channel information.

In some embodiments, the operating channel information indicates the first channel as an operating channel that the first AP is allowed to use to transmit data during the TWT SP of the TWT schedule.

In some embodiments, the method further comprises continuing a transmit opportunity (TXOP) established in the first BSS during the TWT SP of the TWT schedule.

In some embodiments, the second channel is a primary channel and the first channel is a secondary channel.

In some embodiments, the first AP ensures that a first transmit opportunity (TXOP) ends in the first BSS before a start time of a first TWT SP of the TWT schedule and ensures that a second TXOP continues in the first BSS during a second TWT SP of the TWT schedule.

### BRIEF DESCRIPTION OF THE DRAWINGS

FIG. 1 shows an example of a wireless network in accordance with an embodiment.

FIG. 2A shows an example of AP in accordance with an embodiment.

FIG. 2B shows an example of STA in accordance with an embodiment.

FIG. 3 shows an example of multi-link communication operation in accordance with an embodiment.

FIG. 4 shows an example of individual TWT operation in accordance with an embodiment.

FIG. 5 shows an example of broadcast TWT operation in accordance with an embodiment.

FIG. 6 illustrates a mode of multi-AP R-TWT coordination where an AP ends a TXOP in accordance with an embodiment.

FIG. 7 illustrates a mode of Multi-AP R-TWT coordination where shared AP's and its associated STAs' TXOP (if they have one) needs to end before the sharing AP's R-TWT SP in accordance with an embodiment.

FIG. 8 illustrates a mode of multi-AP R-TWT coordination where transmission from the shared AP or its associated STAs is allowed during the R-TWT SP of the sharing SP in accordance with an embodiment.

FIG. 9 illustrates simultaneous transmission in two BSSs during the R-TWT SP of a sharing AP, where the first BSS operates on a different channel than the second BSS in accordance with an embodiment.

FIG. 10A shows a flow chart of an example process performed by a shared AP for simultaneous transmission on different channels in accordance with an embodiment.

FIG. 10B shows a flow chart of an example process performed by a sharing AP for simultaneous transmission on different channels in accordance with an embodiment.

FIG. 11 illustrates several different APs, with some APs observing only certain R-TWT SPs and unobserving other R-TWT SPs of a R-TWT scheduled AP in accordance with an embodiment.

FIG. 12 illustrates a TWT element in accordance with an embodiment.

In one or more implementations, not all of the depicted components in each figure may be required, and one or more implementations may include additional components not shown in a figure. Variations in the arrangement and type of the components may be made without departing from the scope of the subject disclosure. Additional components, different components, or fewer components may be utilized within the scope of the subject disclosure.

### DETAILED DESCRIPTION

The detailed description set forth below, in connection with the appended drawings, is intended as a description of various implementations and is not intended to represent the only implementations in which the subject technology may be practiced. Rather, the detailed description includes specific details for the purpose of providing a thorough understanding of the inventive subject matter. As those skilled in the art would realize, the described implementations may be modified in various ways, all without departing from the scope of the present disclosure. Accordingly, the drawings and description are to be regarded as illustrative in nature and not restrictive. Like reference numerals designate like elements.

The following description is directed to certain implementations for the purpose of describing the innovative aspects of this disclosure. However, a person having ordinary skill in the art will readily recognize that the teachings herein can be applied in a multitude of different ways. The examples in this disclosure are based on WLAN communication according to the Institute of Electrical and Electronics Engineers (IEEE) 802.11 standard, including IEEE 802.11be standard and any future amendments to the IEEE 802.11 standard. However, the described embodiments may be implemented in any device, system or network that is capable of transmitting and receiving radio frequency (RF) signals according to the IEEE 802.11 standard, the Bluetooth standard, Global System for Mobile communications (GSM), GSM/General Packet Radio Service (GPRS), Enhanced Data GSM Environment (EDGE), Terrestrial Trunked Radio (TETRA), Wideband-CDMA (W-CDMA), Evolution Data Optimized (EV-DO), 1×EV-DO, EV-DO Rev A, EV-DO Rev B, High Speed Packet Access (HSPA), High Speed Downlink Packet Access (HSDPA), High Speed Uplink Packet Access (HSUPA), Evolved High Speed Packet Access (HSPA+), Long Term Evolution (LTE), 5G NR (New Radio), AMPS, or other known signals that are used to communicate within a wireless, cellular or internet of things (IoT) network, such as a system utilizing 3G, 4G, 5G, 6G, or further implementations thereof, technology.

Depending on the network type, other well-known terms may be used instead of “access point” or “AP,” such as “router” or “gateway.” For the sake of convenience, the term “AP” is used in this disclosure to refer to network infrastructure components that provide wireless access to remote terminals. In WLAN, given that the AP also contends for the wireless channel, the AP may also be referred to as a STA. Also, depending on the network type, other well-known terms may be used instead of “station” or “STA,” such as “mobile station,” “subscriber station,” “remote terminal,” “user equipment,” “wireless terminal,” or “user device.” For the sake of convenience, the terms “station” and “STA” are used in this disclosure to refer to remote wireless equipment that wirelessly accesses an AP or contends for a wireless channel in a WLAN, whether the STA is a mobile device (such as a mobile telephone or smartphone) or is normally considered a stationary device (such as a desktop computer, AP, media player, stationary sensor, television, etc.).

Multi-link operation (MLO) is a key feature that is currently being developed by the standards body for next generation extremely high throughput (EHT) Wi-Fi systems in IEEE 802.11be. The Wi-Fi devices that support MLO are referred to as multi-link devices (MLD). With MLO, it is possible for a non-AP MLD to discover, authenticate, associate, and set up multiple links with an AP MLD. Channel access and frame exchange is possible on each link between the AP MLD and non-AP MLD.

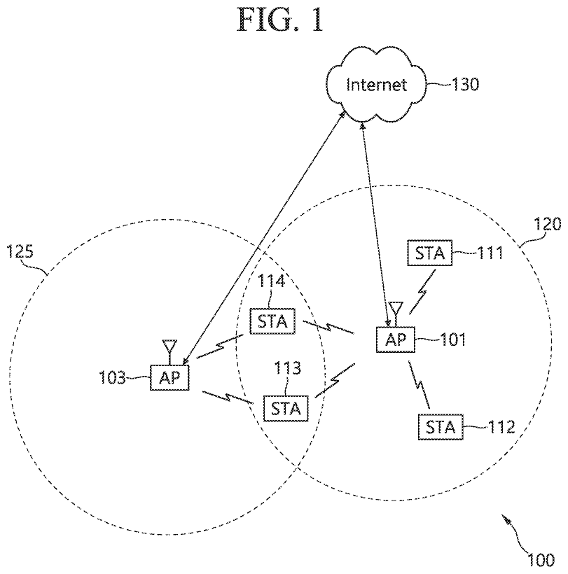

FIG. 1 shows an example of a wireless network 100 in accordance with an embodiment. The embodiment of the wireless network 100 shown in FIG. 1 is for illustrative purposes only. Other embodiments of the wireless network 100 could be used without departing from the scope of this disclosure.

As shown in FIG. 1, the wireless network 100 may include a plurality of wireless communication devices. Each wireless communication device may include one or more stations (STAs). The STA may be a logical entity that is a singly addressable instance of a medium access control (MAC) layer and a physical (PHY) layer interface to the wireless medium. The STA may be classified into an access point (AP) STA and a non-access point (non-AP) STA. The AP STA may be an entity that provides access to the distribution system service via the wireless medium for associated STAs. The non-AP STA may be a STA that is not contained within an AP-STA. For the sake of simplicity of description, an AP STA may be referred to as an AP and a non-AP STA may be referred to as a STA. In the example of FIG. 1, APs 101 and 103 are wireless communication devices, each of which may include one or more AP STAs. In such embodiments, APs 101 and 103 may be AP multi-link device (MLD). Similarly, STAs 111-114 are wireless communication devices, each of which may include one or more non-AP STAs. In such embodiments, STAs 111-114 may be non-AP MLD.

The APs 101 and 103 communicate with at least one network 130, such as the Internet, a proprietary Internet Protocol (IP) network, or other data network. The AP 101 provides wireless access to the network 130 for a plurality of stations (STAs) 111-114 with a coverage are 120 of the AP 101. The APs 101 and 103 may communicate with each other and with the STAs using Wi-Fi or other WLAN communication techniques.

Depending on the network type, other well-known terms may be used instead of “access point” or “AP,” such as “router” or “gateway.” For the sake of convenience, the term “AP” is used in this disclosure to refer to network infrastructure components that provide wireless access to remote terminals. In WLAN, given that the AP also contends for the wireless channel, the AP may also be referred to as a STA. Also, depending on the network type, other well-known terms may be used instead of “station” or “STA,” such as “mobile station,” “subscriber station,” “remote terminal,” “user equipment,” “wireless terminal,” or “user device.” For the sake of convenience, the terms “station” and “STA” are used in this disclosure to refer to remote wireless equipment that wirelessly accesses an AP or contends for a wireless channel in a WLAN, whether the STA is a mobile device (such as a mobile telephone or smartphone) or is normally considered a stationary device (such as a desktop computer, AP, media player, stationary sensor, television, etc.).

In FIG. 1, dotted lines show the approximate extents of the coverage area 120 and 125 of APs 101 and 103, which are shown as approximately circular for the purposes of illustration and explanation. It should be clearly understood that coverage areas associated with APs, such as the coverage areas 120 and 125, may have other shapes, including irregular shapes, depending on the configuration of the APs.

As described in more detail below, one or more of the APs may include circuitry and/or programming for management of MU-MIMO and OFDMA channel sounding in WLANs. Although FIG. 1 shows one example of a wireless network 100, various changes may be made to FIG. 1. For example, the wireless network 100 could include any number of APs and any number of STAs in any suitable arrangement. Also, the AP 101 could communicate directly with any number of STAs and provide those STAs with wireless broadband access to the network 130. Similarly, each AP 101 and 103 could communicate directly with the network 130 and provides STAs with direct wireless broadband access to the network 130. Further, the APs 101 and/or 103 could provide access to other or additional external networks, such as external telephone networks or other types of data networks.

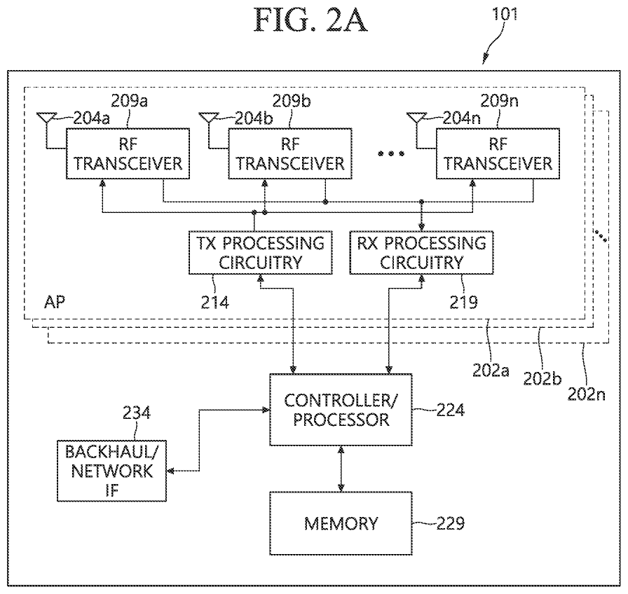

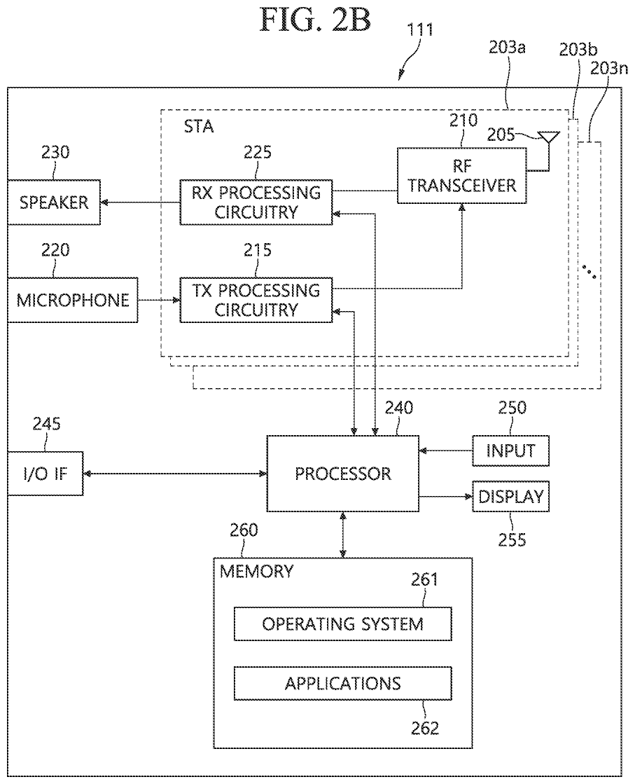

FIG. 2A shows an example of AP 101 in accordance with an embodiment. The embodiment of the AP 101 shown in FIG. 2A is for illustrative purposes, and the AP 103 of FIG. 1 could have the same or similar configuration. However, APs come in a wide range of configurations, and FIG. 2A does not limit the scope of this disclosure to any particular implementation of an AP.

As shown in FIG. 2A, the AP 101 may include multiple antennas 204a-204n, multiple radio frequency (RF) transceivers 209a-209n, transmit (TX) processing circuitry 214, and receive (RX) processing circuitry 219. The AP 101 also may include a controller/processor 224, a memory 229, and a backhaul or network interface 234. The RF transceivers 209a-209n receive, from the antennas 204a-204n, incoming RF signals, such as signals transmitted by STAs in the network 100. The RF transceivers 209a-209n down-convert the incoming RF signals to generate intermediate (IF) or baseband signals. The IF or baseband signals are sent to the RX processing circuitry 219, which generates processed baseband signals by filtering, decoding, and/or digitizing the baseband or IF signals. The RX processing circuitry 219 transmits the processed baseband signals to the controller/processor 224 for further processing.

The TX processing circuitry 214 receives analog or digital data (such as voice data, web data, e-mail, or interactive video game data) from the controller/processor 224. The TX processing circuitry 214 encodes, multiplexes, and/or digitizes the outgoing baseband data to generate processed baseband or IF signals. The RF transceivers 209a-209n receive the outgoing processed baseband or IF signals from the TX processing circuitry 214 and up-converts the baseband or IF signals to RF signals that are transmitted via the antennas 204a-204n.

The controller/processor 224 can include one or more processors or other processing devices that control the overall operation of the AP 101. For example, the controller/processor 224 could control the reception of uplink signals and the transmission of downlink signals by the RF transceivers 209a-209n, the RX processing circuitry 219, and the TX processing circuitry 214 in accordance with well-known principles. The controller/processor 224 could support additional functions as well, such as more advanced wireless communication functions. For instance, the controller/processor 224 could support beam forming or directional routing operations in which outgoing signals from multiple antennas 204a-204n are weighted differently to effectively steer the outgoing signals in a desired direction. The controller/processor 224 could also support OFDMA operations in which outgoing signals are assigned to different subsets of subcarriers for different recipients (e.g., different STAs 111-114). Any of a wide variety of other functions could be supported in the AP 101 by the controller/processor 224 including a combination of DL MU-MIMO and OFDMA in the same transmit opportunity. In some embodiments, the controller/processor 224 may include at least one microprocessor or microcontroller. The controller/processor 224 is also capable of executing programs and other processes resident in the memory 229, such as an OS. The controller/processor 224 can move data into or out of the memory 229 as required by an executing process.

The controller/processor 224 is also coupled to the backhaul or network interface 234. The backhaul or network interface 234 allows the AP 101 to communicate with other devices or systems over a backhaul connection or over a network. The interface 234 could support communications over any suitable wired or wireless connection(s). For example, the interface 234 could allow the AP 101 to communicate over a wired or wireless local area network or over a wired or wireless connection to a larger network (such as the Internet). The interface 234 may include any suitable structure supporting communications over a wired or wireless connection, such as an Ethernet or RF transceiver. The memory 229 is coupled to the controller/processor 224. Part of the memory 229 could include a RAM, and another part of the memory 229 could include a Flash memory or other ROM.

As described in more detail below, the AP 101 may include circuitry and/or programming for management of channel sounding procedures in WLANs. Although FIG. 2A illustrates one example of AP 101, various changes may be made to FIG. 2A. For example, the AP 101 could include any number of each component shown in FIG. 2A. As a particular example, an AP could include a number of interfaces 234, and the controller/processor 224 could support routing functions to route data between different network addresses. As another example, while shown as including a single instance of TX processing circuitry 214 and a single instance of RX processing circuitry 219, the AP 101 could include multiple instances of each (such as one per RF transceiver). Alternatively, only one antenna and RF transceiver path may be included, such as in legacy APs. Also, various components in FIG. 2A could be combined, further subdivided, or omitted and additional components could be added according to particular needs.

As shown in FIG. 2A, in some embodiment, the AP 101 may be an AP MLD that includes multiple APs 202a-202n. Each AP 202a-202n is affiliated with the AP MLD 101 and includes multiple antennas 204a-204n, multiple radio frequency (RF) transceivers 209a-209n, transmit (TX) processing circuitry 214, and receive (RX) processing circuitry 219. Each APs 202a-202n may independently communicate with the controller/processor 224 and other components of the AP MLD 101. FIG. 2A shows that each AP 202a-202n has separate multiple antennas, but each AP 202a-202n can share multiple antennas 204a-204n without needing separate multiple antennas. Each AP 202a-202n may represent a physical (PHY) layer and a lower media access control (MAC) layer.

FIG. 2B shows an example of STA 111 in accordance with an embodiment. The embodiment of the STA 111 shown in FIG. 2B is for illustrative purposes, and the STAs 111-114 of FIG. 1 could have the same or similar configuration. However, STAs come in a wide variety of configurations, and FIG. 2B does not limit the scope of this disclosure to any particular implementation of a STA.

As shown in FIG. 2B, the STA 111 may include antenna(s) 205, a RF transceiver 210, TX processing circuitry 215, a microphone 220, and RX processing circuitry 225. The STA 111 also may include a speaker 230, a controller/processor 240, an input/output (I/O) interface (IF) 245, a touchscreen 250, a display 255, and a memory 260. The memory 260 may include an operating system (OS) 261 and one or more applications 262.

The RF transceiver 210 receives, from the antenna(s) 205, an incoming RF signal transmitted by an AP of the network 100. The RF transceiver 210 down-converts the incoming RF signal to generate an IF or baseband signal. The IF or baseband signal is sent to the RX processing circuitry 225, which generates a processed baseband signal by filtering, decoding, and/or digitizing the baseband or IF signal. The RX processing circuitry 225 transmits the processed baseband signal to the speaker 230 (such as for voice data) or to the controller/processor 240 for further processing (such as for web browsing data).

The TX processing circuitry 215 receives analog or digital voice data from the microphone 220 or other outgoing baseband data (such as web data, e-mail, or interactive video game data) from the controller/processor 240. The TX processing circuitry 215 encodes, multiplexes, and/or digitizes the outgoing baseband data to generate a processed baseband or IF signal. The RF transceiver 210 receives the outgoing processed baseband or IF signal from the TX processing circuitry 215 and up-converts the baseband or IF signal to an RF signal that is transmitted via the antenna(s) 205.

The controller/processor 240 can include one or more processors and execute the basic OS program 261 stored in the memory 260 in order to control the overall operation of the STA 111. In one such operation, the controller/processor 240 controls the reception of downlink signals and the transmission of uplink signals by the RF transceiver 210, the RX processing circuitry 225, and the TX processing circuitry 215 in accordance with well-known principles. The controller/processor 240 can also include processing circuitry configured to provide management of channel sounding procedures in WLANs. In some embodiments, the controller/processor 240 may include at least one microprocessor or microcontroller.

The controller/processor 240 is also capable of executing other processes and programs resident in the memory 260, such as operations for management of channel sounding procedures in WLANs. The controller/processor 240 can move data into or out of the memory 260 as required by an executing process. In some embodiments, the controller/processor 240 is configured to execute a plurality of applications 262, such as applications for channel sounding, including feedback computation based on a received null data packet announcement (NDPA) and null data packet (NDP) and transmitting the beamforming feedback report in response to a trigger frame (TF). The controller/processor 240 can operate the plurality of applications 262 based on the OS program 261 or in response to a signal received from an AP. The controller/processor 240 is also coupled to the I/O interface 245, which provides STA 111 with the ability to connect to other devices such as laptop computers and handheld computers. The I/O interface 245 is the communication path between these accessories and the main controller/processor 240.

The controller/processor 240 is also coupled to the input 250 (such as touchscreen) and the display 255. The operator of the STA 111 can use the input 250 to enter data into the STA 111. The display 255 may be a liquid crystal display, light emitting diode display, or other display capable of rendering text and/or at least limited graphics, such as from web sites. The memory 260 is coupled to the controller/processor 240. Part of the memory 260 could include a random access memory (RAM), and another part of the memory 260 could include a Flash memory or other read-only memory (ROM).

Although FIG. 2B shows one example of STA 111, various changes may be made to FIG. 2B. For example, various components in FIG. 2B could be combined, further subdivided, or omitted and additional components could be added according to particular needs. In particular examples, the STA 111 may include any number of antenna(s) 205 for MIMO communication with an AP 101. In another example, the STA 111 may not include voice communication or the controller/processor 240 could be divided into multiple processors, such as one or more central processing units (CPUs) and one or more graphics processing units (GPUs). Also, while FIG. 2B illustrates the STA 111 configured as a mobile telephone or smartphone, STAs could be configured to operate as other types of mobile or stationary devices.

As shown in FIG. 2B, in some embodiment, the STA 111 may be a non-AP MLD that includes multiple STAs 203a-203n. Each STA 203a-203n is affiliated with the non-AP MLD 111 and includes an antenna(s) 205, a RF transceiver 210, TX processing circuitry 215, and RX processing circuitry 225. Each STAs 203a-203n may independently communicate with the controller/processor 240 and other components of the non-AP MLD 111. FIG. 2B shows that each STA 203a-203n has a separate antenna, but each STA 203a-203n can share the antenna 205 without needing separate antennas. Each STA 203a-203n may represent a physical (PHY) layer and a lower media access control (MAC) layer.

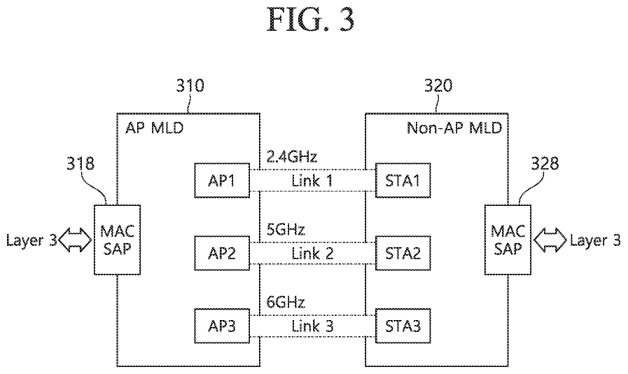

FIG. 3 shows an example of multi-link communication operation in accordance with an embodiment. The multi-link communication operation may be usable in IEEE 802.11be standard and any future amendments to IEEE 802.11 standard. In FIG. 3, an AP MLD 310 may be the wireless communication device 101 and 103 in FIG. 1 and a non-AP MLD 220 may be one of the wireless communication devices 111-114 in FIG. 1.

As shown in FIG. 3, the AP MLD 310 may include a plurality of affiliated APs, for example, including AP 1, AP 2, and AP 3. Each affiliated AP may include a PHY interface to wireless medium (Link 1, Link 2, or Link 3). The AP MLD 310 may include a single MAC service access point (SAP) 318 through which the affiliated APs of the AP MLD 310 communicate with a higher layer (Layer 3 or network layer). Each affiliated AP of the AP MLD 310 may have a MAC address (lower MAC address) different from any other affiliated APs of the AP MLD 310. The AP MLD 310 may have a MLD MAC address (upper MAC address) and the affiliated APs share the single MAC SAP 318 to Layer 3. Thus, the affiliated APs share a single IP address, and Layer 3 recognizes the AP MLD 310 by assigning the single IP address.

The non-AP MLD 320 may include a plurality of affiliated STAs, for example, including STA 1, STA 2, and STA 3. Each affiliated STA may include a PHY interface to the wireless medium (Link 1, Link 2, or Link 3). The non-AP MLD 320 may include a single MAC SAP 328 through which the affiliated STAs of the non-AP MLD 320 communicate with a higher layer (Layer 3 or network layer). Each affiliated STA of the non-AP MLD 320 may have a MAC address (lower MAC address) different from any other affiliated STAs of the non-AP MLD 320. The non-AP MLD 320 may have a MLD MAC address (upper MAC address) and the affiliated STAs share the single MAC SAP 328 to Layer 3. Thus, the affiliated STAs share a single IP address, and Layer 3 recognizes the non-AP MLD 320 by assigning the single IP address.

The AP MLD 310 and the non-AP MLD 320 may set up multiple links between their affiliate APs and STAs. In this example, the AP 1 and the STA 1 may set up Link 1 which operates in 2.4 GHz band. Similarly, the AP 2 and the STA 2 may set up Link 2 which operates in 5 GHZ band, and the AP 3 and the STA 3 may set up Link 3 which operates in 6 GHz band. Each link may enable channel access and frame exchange between the AP MLD 310 and the non-AP MLD 320 independently, which may increase date throughput and reduce latency. Upon associating with an AP MLD on a set of links (setup links), each non-AP device is assigned a unique association identifier (AID).

The following documents are hereby incorporated by reference in their entirety into the present disclosure as if fully set forth herein: i) IEEE 802.11-2020, “Wireless LAN Medium Access Control (MAC) and Physical Layer (PHY) Specifications” and ii) IEEE P802.11bc/D3.0, “Wireless LAN Medium Access Control (MAC) and Physical Layer (PHY) Specifications.”

Target wake time (TWT) operation is a feature of power management in WLAN networks. The TWT operation has been introduced in IEEE 802.11ah standard and later modified in IEEE 802.11ax standard. The TWT operation enables an AP to manage activity in the basic service set (BSS) to minimize contention between STAs and reduce the required wake times for STAs during the TWT operation. It may be achieved by allocating STAs to operate at non-overlapping times or frequencies and perform the frame exchange sequences in pre-scheduled service periods. In TWT operation, a STA can wake up at pre-scheduled times that have been negotiated with an AP or another STA in the BSS. The STA does not need to be aware of TWT parameter values of other STAs within the BSS or of STAs in other BSSs. The STA does not need to be aware that a TWT service period (SP) is used to exchange frames with other STAs. Frames transmitted during a TWT SP can employ any physical layer protocol data unit (PPDU) format supported by the pair of STAs that have established the corresponding TWT agreement, including, but not limited to, high efficiency multi-user physical layer protocol data unit (HE MU PPDU), high efficiency trigger based physical layer protocol data unit (TB PPDU).

IEEE 802.11 standard describes two types of TWT operations: individual TWT operation and broadcast TWT operation. In the individual TWT operation, an individual TWT agreement can be established between two STAs or between a STA and an AP. The negotiation for the individual TWT operation may take place on an individual basis between two STAs or between a STA and an AP. An AP may have TWT agreements with multiple STAs. Any changes in the TWT agreement between the AP and one STA do not affect the TWT agreement between the AP and other STA.

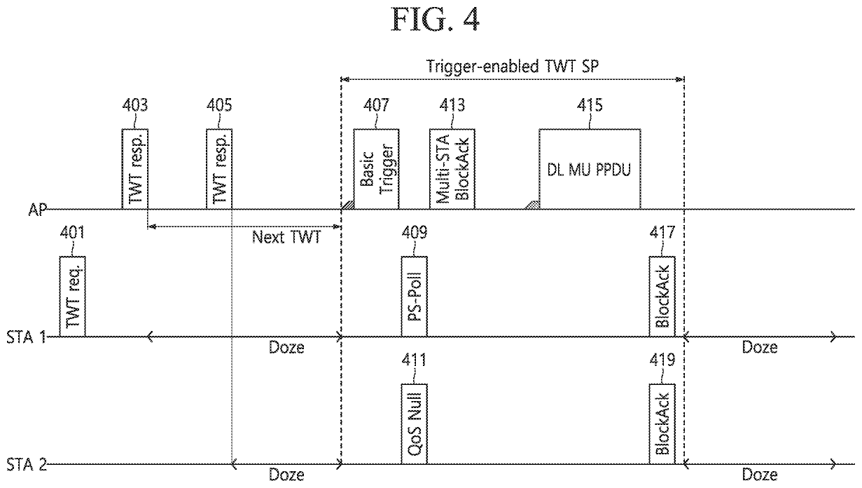

FIG. 4 shows an example of individual TWT operation in accordance with an embodiment. The operation depicted in FIG. 4 is for illustration purposes and does not limit the scope of this disclosure to any particular implementations.

In FIG. 4, STA 1 and STA 2 are TWT requesting STAs and AP is a TWT responding STA. In the example of FIG. 4, the STA 1 sends a TWT request 401 to the AP to setup a trigger-enabled TWT agreement. The AP accepts the TWT request 401 with STA 1 and confirms the acceptance in TWT response 403 sent to STA 1. Subsequently, the AP sends an unsolicited TWT response 405 to STA 2 to set up a trigger-enabled TWT agreement with STA 2. Both these TWT agreements are set up as announced TWTs. During the trigger-enabled TWT SP, the AP sends a Basic Trigger frame 407 to the TWT requesting STAs (STA 1 and STA 2) which may indicate that they are awake during the TWT SP. The STA 1 indicates that it is awake by sending a Power-Saving Poll frame (PS-Poll frame) 409, and the STA 2 indicates that it is awake by sending a Quality of Service (QOS) Null frame 411 in response to the Basic Trigger frame 407. Subsequently, the AP sends a Multi-Station Block Acknowledgement (Multi-STA Block Ack) 413 frame and Downlink (DL) Multi-User (MU) physical layer protocol data unit (PPDU) 415 to both STA 1 and STA 2. Afterward, the STA 1 and STA 2 respectively send BlockAck frames 417 and 419 to the AP, and then go to doze state.

The broadcast TWT operates in a membership-based approach. In broadcast TWT operation, an AP can set up a shared TWT session for a group of STAs. The AP is typically the controller of the broadcast TWT schedule. The non-AP STAs in the BSS can request membership in the broadcast TWT schedule, or the AP can send unsolicited response to a STA to make the STA a member of the broadcast TWT schedule that the AP maintains in the BSS. The AP may advertise and maintain multiple broadcast TWT schedules in the BSS. When a change is made to any broadcast TWT schedules in the BSS, it may affect all or some of STAs that are members of the corresponding broadcast TWT schedule.

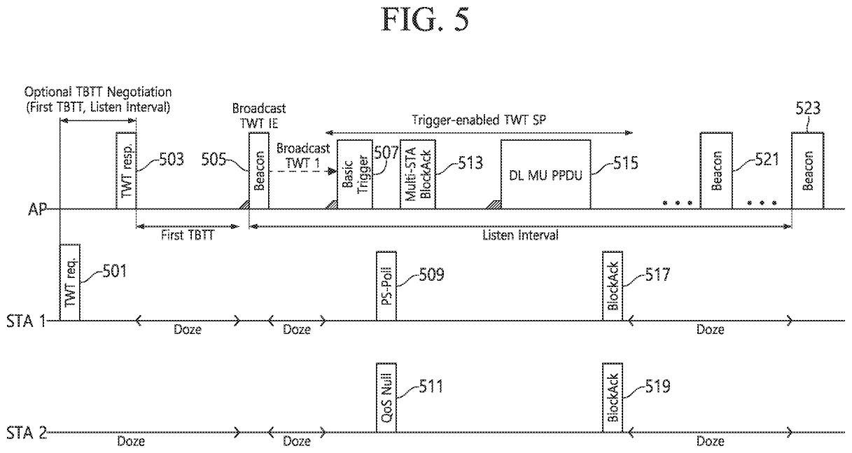

FIG. 5 shows an example of broadcast TWT operation in accordance with an embodiment. The operation depicted in FIG. 5 is for illustration purposes and does not limit the scope of this disclosure to any particular implementations.

In FIG. 5, STA 1 and STA 2 are TWT scheduled STAs and AP is a TWT scheduling AP. In the example of FIG. 5, the STA 1 and the AP may have optional target beacon transmission time (TBTT) negotiation by exchanging TWT request frame 501 and TWT response frame 503. After the first TBTT, the AP sends a beacon frame 505 including a broadcast TWT element that indicates a broadcast TWT SP. During the TWT SP, the AP may send trigger frames, or downlink buffer-able units (BUs) to the TWT scheduled STAs (STA 1 and STA 2). STA 1 and STA 2 wake to receive the beacon frame 505 to determine the broadcast TWT. During the trigger-enabled TWT SP, the AP sends a basic trigger frame 507 to STA 1 and STA 2 which indicate that they are awake during the TWT SP. STA 1 indicates that it is awake by sending a PS-Poll frame 509, while STA 2 indicates that it is awake by sending a QoS Null frame 511 in response to the basic trigger frame 507. STA 1 and STA 2 receive their DL BUs in a subsequent frame exchange (e.g., Multi-STA BlockAck 513, DL MU PPDU 515, and BlockAck 517 and 519) with the AP and go to doze state out of the TWT SP. After the TWT SP, the AP sends beacon frames 521 and 523 periodically to STA 1 and STA 2. As illustrated, the AP can advertise/announce and maintain multiple broadcast TWT schedules in the BSS. When a change is made to any of the broadcast TWT schedules, it may affect all STAs that are members of the particular schedule.

Restricted TWT (R-TWT) operation is a feature that provides better support for latency sensitive applications in WLAN networks. The R-TWT operation has been introduced in IEEE 802.11be standard. The R-TWT operation may offer a protected service period (SP) for R-TWT member STAs by sending Quiet elements to non-member STAs in the BSS in the R-TWT schedule. In some implementations, a quiet interval of the Quiet element overlaps with the initial portion of the R-TWT SP. Therefore, it may provide more channel access opportunity to the R-TWT member STAs than non-member STAs, thereby improving the flow of latency sensitive traffic.

Interference from one BSS often causes performance issues for STAs and APs in nearby BSSs. This may result in overall throughput degradation in the network. The Overlapping BSS (OBSS) interference can also increase the overall latency since it may take more time for accessing the channel due to the interference occupying the channel. If a STA in a BSS has latency-sensitive traffic, this delay in channel access can seriously hamper the STA's latency-sensitive applications.

Therefore, multi-AP coordination may be an important feature for next generation WLN to address the interference issues from OBSS. Various modes of R-TWT based multi-AP coordination mechanisms are developed. In different modes of R-TWT based multi-AP coordination mechanism, the shared AP and any STA associated with the shared AP may need to end any TXOP (if it has one) before the R-TWT SP of the sharing AP starts. Moreover, in some modes of R-TWT coordination, the shared AP and any STAs associated with the shared AP may not be allowed to transmit frames during the R-TWT SP of the sharing AP. This may degrade the overall performance of the shared AP's BSS. As described herein, the terms “R-TWT sharing AP”, “TWT-sharing AP”, and “sharing AP” can be used interchangeably. Likewise, the terms “R-TWT shared AP”, “TWT shared AP”, and “shared AP” can be used interchangeably.

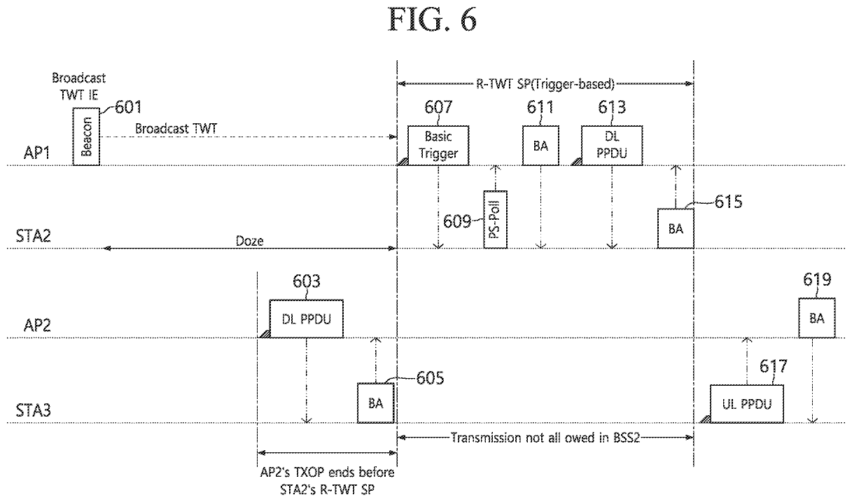

FIG. 6 illustrates a mode of multi-AP R-TWT coordination where an AP ends a TXOP in accordance with an embodiment. In particular, FIG. 6 illustrates a mode of multi-AP R-TWT coordination where shared AP's and its associated STAs' TXOP (if they have one) needs to end before the sharing AP's R-TWT SP and no transmission is allowed from the shared AP or its associated STA during the R-TWT SP of the sharing AP. In FIG. 6, AP1 is the sharing AP and AP2 is the shared AP.

As illustrated in FIG. 6, the AP1 sends a beacon frame 601 including a broadcast TWT element that indicates a broadcast TWT SP. AP1 and STA2 may operate in a BSS1 and AP2 and STA3 may be operate in a BSS2. Initially, STA2 is in a doze state, and AP2 and STA3 have a TXOP where there is a frame exchange (e.g., DL PPDU 603, BlockAck 605).

However, the TXOP established between AP2 and STA3 needs to end before the start time of R-TWT SP in BSS 1, and no transmission is allowed in BSS2 from AP2 to STA3 during the R-TWT SP of AP1.

STA2 wakes to receive the beacon frame 601 to determine the broadcast TWT. During the trigger-enabled R-TWT SP of AP1, the AP1 sends a basic trigger frame 607 to STA2. STA2 indicates that it is awake by sending a PS-Poll frame 609 in response to the basic trigger frame 607. STA2 receives DL BUs in a subsequent frame exchange (e.g., BlockAck 611, DL PPDU 613, and BlockAck 615) with the AP1. After the R-TWT SP of AP1, STA3 transmits uplink (UL) PDDU 617 in a subsequent frame exchange (e.g., UL PPDU 617, BlockAck 619).

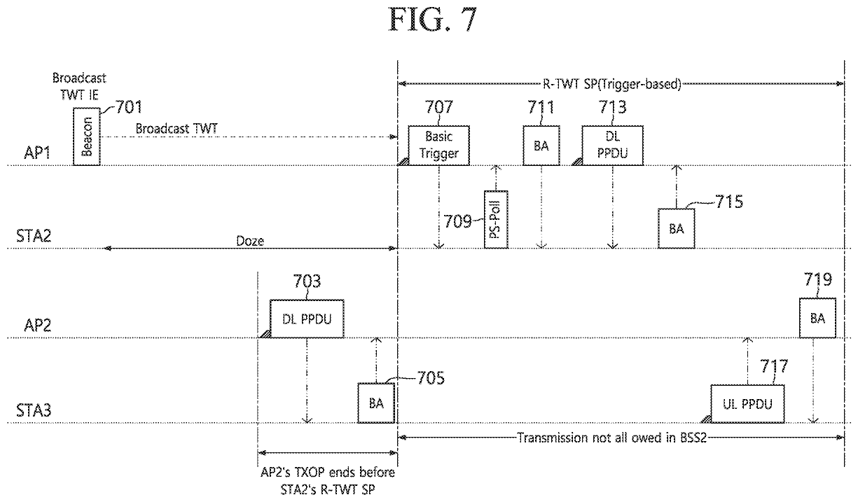

FIG. 7 illustrates a mode of Multi-AP R-TWT coordination where the TXOP of a shared AP (if they have one) needs to end before the sharing AP's R-TWT SP. However, transmission from the shared AP or its associated STAs is allowed during the R-TWT SP of the sharing AP.

In FIG. 7, AP1 is a sharing AP and AP 2 is a shared AP. As illustrated in FIG. 7, AP1 sends a beacon frame 701 including a broadcast TWT element that indicates a broadcast TWT SP. AP1 and STA2 may establish a first R-TWT schedule in a first BSS and AP2 and STA3 may establish a second R-TWT schedule in a second BSS. Initially, STA2 is in a doze state, and AP2 and STA3 have a TXOP where there is a frame exchange (e.g., DL PPDU 703, BlockAck 705).

However, the TXOP of AP2 and STA3 needs to end before the start time of the R-TWT SP of AP1. However, transmission from the shared AP, here AP2, or its associated STAs, here STA3, may be allowed during the R-TWT SP of the sharing AP, here AP1. As illustrated, transmission is allowed in BSS2 from AP2 to STA3 during the R-TWT SP of AP1.

During the R-TWT SP of AP1, the AP1 sends a basic trigger frame 707 to STA2. STA2 indicates that it is awake by sending a PS-Poll frame 709 in response to the basic trigger frame 707. STA2 receives its DL BUs in a subsequent frame exchange (e.g., BlockAck 711, DL PPDU 713, and BlockAck 715) with the AP1. However, during the R-TWT SP of AP1, transmission is allowed between the shared AP, here AP2, and its associated STAs, here STA3. As illustrated, during the R-TWT SP of AP1, STA3 transmits uplink (UL) PDDU 717 in a frame exchange (e.g., UL PPDU 717, BlockAck 719). In some implementations, the AP 1, which is the sharing AP, may indicate a time when the AP 2 or STA 3 is allowed to transmit frames during the R-TWT SP of the AP 1.

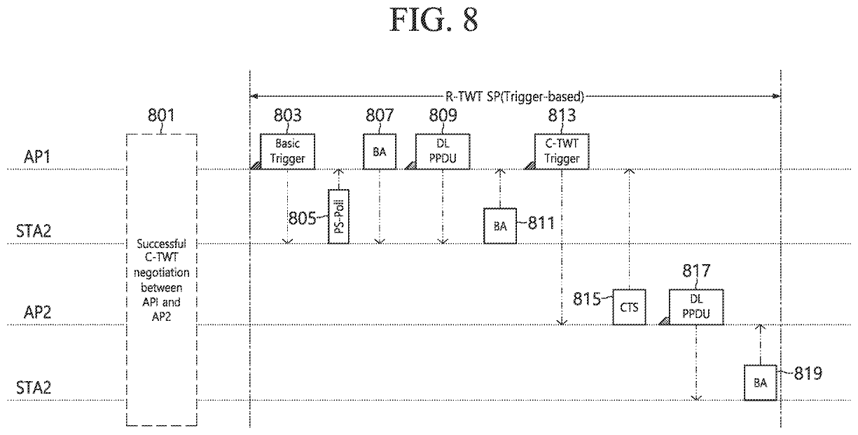

FIG. 8 illustrates a mode of multi-AP R-TWT coordination where transmission from the shared AP or its associated STAs is allowed during the R-TWT SP of the sharing SP only after being triggered by the R-TWT sharing AP.

As illustrated in FIGS. 8, AP1 and AP2 perform a coordinated target-wake-time (C-TWT) negotiation 801. In FIG. 8, AP 1 is a sharing AP and AP 2 is a shared AP. Further, the AP 1 establishes a first R-TWT schedule in the first BSS and the AP 2 establishes a second R-TWT schedule in the second BSS.

During the R-TWT SP of AP1, the AP1 may send trigger frames, or downlink (DL) buffer-able units (BUs) to the TWT scheduled STAs, here STA1. During the trigger-enabled R-TWT SP corresponding to the first R-TWT schedule in the first BSS, the AP1 sends a basic trigger frame 803 to STA1. STA1 indicates that it is awake by sending a PS-Poll frame 805 in response to the basic trigger frame 803. STA1 receives its DL BUs in a subsequent frame exchange (e.g., BlockAck 807, DL PPDU 809, and BlockAck 811) with the AP1. During the R-TWT SP of AP1, AP1 sends a C-TWT Trigger 813 frame to AP2 and AP2 sends a Clear to Send (CTS) frame 815 to AP1, such that transmission is allowed between the shared AP2 and its associated STA2. As illustrated, during the R-TWT SP of AP1, STA2 receives its DL PDDU 817 in a frame exchange (e.g., DL PPDU 817, BlockAck 819).

As described herein, many embodiments can provide a balance between the protection of R-TWT SP of the sharing AP and an overall performance maintenance in the BSS of the shared AP.

Many embodiments can provide, in some modes of R-TWT based multi-AP coordination, not requiring a TXOP to end before the start time of an R-TWT SP of a different TWT schedule by setting the APs to operate on different channels. In particular, in many embodiments, in some mode of R-TWT based multi-AP coordination, a first AP that is an R-TWT sharing AP operating in a first BSS has a first R-TWT schedule established in the first BSS and the first AP is a member of an R-TWT coordinating AP set. Furthermore, a second AP operating in a second BSS is also a member of the R-TWT coordinating AP set and agrees to participate in the R-TWT coordination with the first AP. In this scenario, the second AP and any non-AP STAs associated with the second AP and operating in the second BSS may not end their TXOP before the start time of an R-TWT SP corresponding to the first R-TWT schedule in the first BSS if the first AP and the second AP are operating on different channels (e.g. the first AP operates on primary 20 MHz and the second AP operates on the secondary 20 MHz channel). In certain embodiments, the two operating channels corresponding to the two APs may be sufficiently spaced in frequency.

Many embodiments can provide for concurrent transmission from different APs in different BSSs when the different APs are operating in different channels. In particular, in several embodiments, in some mode of R-TWT based multi-AP coordination, a first AP that is a sharing AP operating in a first BSS has a first R-TWT schedule established in a first BSS and the first AP is a member of an R-TWT coordinating AP set. Furthermore, a second AP operating in a second BSS is also a member of the R-TWT coordinating AP set and agrees to participate in the R-TWT coordination with the first AP. In this scenario, the second AP and any non-AP STAs associated with the second AP and operating in the second BSS may transmit during an R-TWT SP corresponding to the first R-TWT schedule in the first BSS if the first AP and the second AP are operating on different channels.

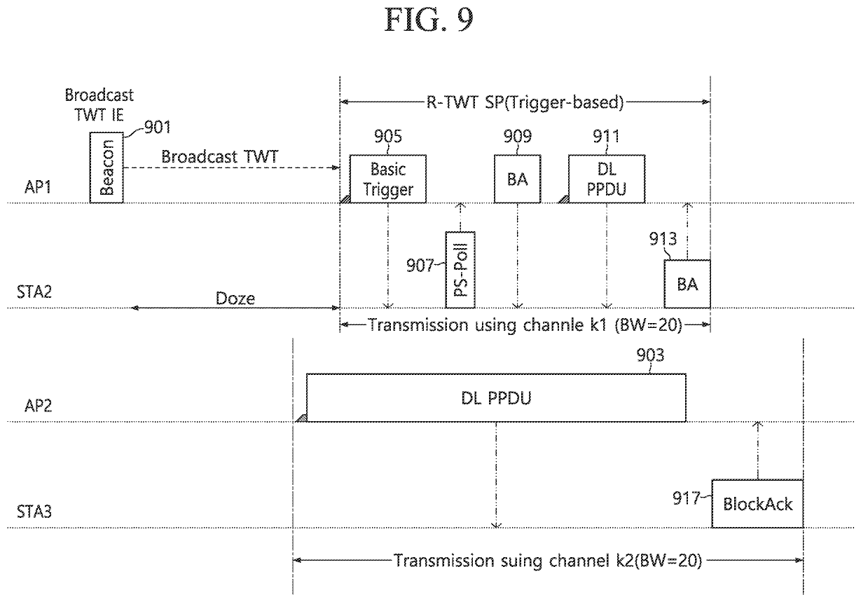

FIG. 9 illustrates simultaneous transmission in two BSSs during the R-TWT SP of a sharing AP in accordance with an embodiment. In FIG. 9, the first BSS operates on a different channel than the second BSS. As such, AP1 and STA2 may establish a first R-TWT schedule in a first BSS and AP2 and STA3 may establish a second R-TWT schedule in a second BSS. In particular, FIG. 9 illustrates a mode of multi-AP R-TWT coordination where the TXOP of shared AP and its associated STAs (if they have one) does not need to end before the sharing AP's R-TWT SP. Furthermore, simultaneous transmission from the shared AP or its associated STA is allowed during the R-TWT SP of the sharing AP.

In particular, in FIG. 9, AP1 is a sharing AP and is an R-TWT scheduling AP. AP2 is a shared AP. Furthermore, AP2 obtains a TXOP and doesn't end its TXOP before the R-TWT SP of AP1 starts. Also, AP2 continues its transmission overlapping it with the R-TWT SP of AP1. In particular, AP1 and AP2 operate on non-overlapping channels.

As illustrated in FIG. 9, the AP1 sends a beacon frame 901 including a broadcast TWT element that indicates a broadcast TWT SP. Initially, STA2 is in a doze state, and AP2 and STA3 have a frame exchange (e.g., DL PPDU 903, BlockAck 917).

In particular, the TXOP of AP2 and STA3 does not need to end before the R-TWT SP of AP1, and simultaneous transmission is allowed in the second BSS from AP2 to STA3 during the trigger-enabled R-TWT SP of AP1, as AP1 and AP2 operate on different channels, in particular AP1 operates on primary 20 MHz channel k1, and AP2 operates on the secondary 20 MHz channel k2.

During the R-TWT SP corresponding to the first R-TWT schedule in the first BSS of AP1 and STA2, the AP1 may send trigger frames, or downlink (DL) buffer-able units (BUs) to the TWT scheduled STAs (STA2). STA2 wakes to receive the beacon frame 901 to determine the broadcast TWT. During the trigger-enabled R-TWT SP corresponding to the first R-TWT schedule in the first BSS, the AP1 sends a basic trigger frame 905 to STA2, which indicates that it is awake during the R-TWT SP. STA2 indicates that it is awake by sending a PS-Poll frame 907 in response to the basic trigger frame 905. STA2 receives its DL BUs in a subsequent frame exchange (e.g., BlockAck 909, DL PPDU 911, and BlockAck 913) with the AP1. During the R-TWT SP of AP1, STA3 receives DL PDDU 903 in a simultaneous frame exchange (e.g., DL PPDU 903, BlockAck 911), as the two BSSs are using different channels for transmission.

In many embodiments, in order to ensure that a second AP operates on a different channel during the R-TWT SP of a first AP's BSS, during the R-TWT negotiation, the first AP can send a message (e.g. a management frame, among other types of frames) to the second AP indicating the R-TWT schedule as well as operating channel the first AP intends to use for communication during the R-TWT SP.

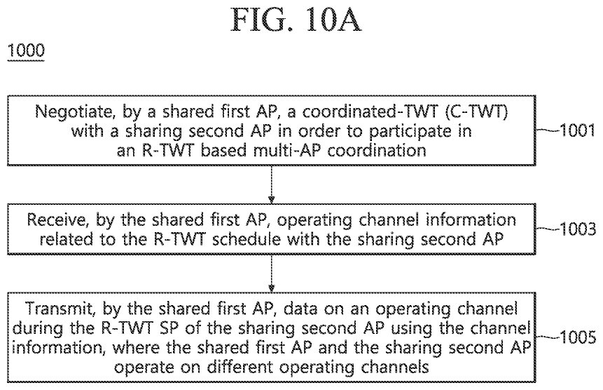

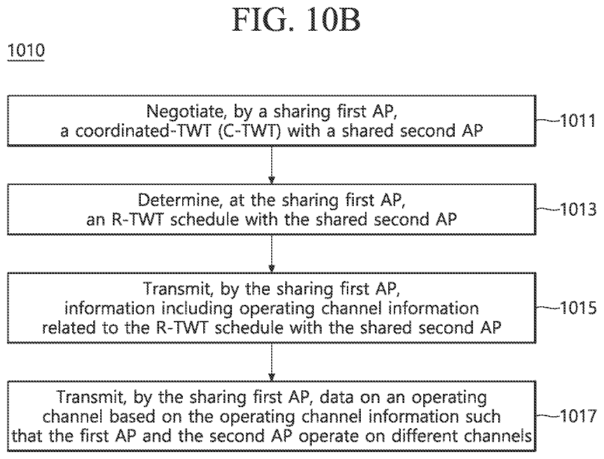

FIG. 10A shows a flow chart of an example process for simultaneous transmission on different channels in accordance with an embodiment. For explanatory and illustration purposes, the example process 1000 may be performed by an AP (e.g., AP1 and/or AP2 in FIG. 9, among others), particularly when the APs intend to establish simultaneous transmission in different channels. Although one or more operations are described or shown in particular sequential order, in other embodiments the operations may be rearranged in a different order, which may include performance of multiple operations in at least partially overlapping time periods.

The process 1000 may begin in operation 1001. In operation 1001, a first AP, that is a shared AP, that intends to participate in an R-TWT based multi-AP coordination can negotiate a coordinated-TWT (C-TWT) with a second AP that is a sharing AP.

In operation 1003, the first AP can receive information including operating channel on which an R-TWT schedule is established by the second AP. In many embodiments, the second AP may transmit a message to the first AP indicating the R-TWT schedule and the operating channel (e.g., the first channel) the second AP intends to use during an R-TWT SP. Accordingly, in many embodiments, the first AP can observe the channel that will be used by the second AP during the second AP's R-TWT SP and can select a different channel (e.g., a second channel) for transmission in the BSS during the R-TWT SP of the second AP that would not cause interference with the second AP's operating channel. In certain embodiments, the first AP can receive a message from the second AP indicating the operating channel that the first AP should use during the R-TWT SP of the second AP.

In operation 1005, the first AP can transmit, during an R-TWT service period (SP) of the second AP, data on an operating channel based on the operating channel information such that the first AP and the second AP operate on different channels.

FIG. 10B shows a flow chart of an example process performed by a sharing AP for simultaneous transmission on different channels in accordance with an embodiment. For explanatory and illustration purposes, the example process 1010 may be performed by an AP (e.g., AP1 and/or AP2 in FIG. 9, among others), particularly when the APs intend to establish simultaneous transmission in different channels. Although one or more operations are described or shown in particular sequential order, in other embodiments the operations may be rearranged in a different order, which may include performance of multiple operations in at least partially overlapping time periods.

The process 1010 may begin in operation 1011. In operation 1011, a first AP that is a sharing AP can negotiate a coordinated-TWT (C-TWT) with a second AP that is a shared AP.

In operation 1013, the first AP can determine information including operating channel information related to an R-TWT schedule with the second AP.

In operation 1015, the first AP can transmit to the second AP information regarding the R-TWT schedule and the operating channel (e.g., the first channel) the first AP intends to use during an R-TWT SP. Accordingly, in many embodiments, the second AP can observe the channel that will be used by the first AP during the first AP's R-TWT SP and can select a different channel (e.g., a second channel) for transmission in the BSS during the R-TWT SP of the first AP that would not cause interference with the first AP's operating channel. In certain embodiments, the first AP can transmit a message to the second AP indicating the operating channel that the second AP should use during the R-TWT SP of the first AP.

In operation 1017, the first AP can transmit data on an operating channel based on the operating channel information such that the first AP and the second AP operate on different channels.

In many embodiments, an AP can encode the one or more channels that the AP intends to use during the R-TWT SP using a bit field in a TWT element. In certain embodiments, a bit field can be a three or four bits fields in a TWT element. For example, a channel C1, BW B1 can be encoded by 000 bits; a channel C2, BW B2 can be encoded by 001 bits, and other channels can follow accordingly. In certain embodiments, an AP can use an R-TWT Bandwidth bitmap in an R-TWT coordination message that the AP can send to a second AP, and the bitmap can encode the one or more channels that the AP intends to use during the R-TWT SP of the AP.

In many embodiments, in some mode of R-TWT based multi-AP coordination, a first AP that is a sharing AP operating in a first BSS has a first R-TWT schedule established in the first BSS and the first AP is also a member of an R-TWT coordinating AP set. Furthermore if a second AP operating in a second BSS is also a member of the R-TWT coordinating AP set and agrees to participate in the R-TWT coordination with the first AP. In this scenario then the second AP may choose to follow R-TWT rules for some selected R-TWT SP corresponding to the first AP's R-TWT schedule and may not follow R-TWT rules for other R-TWT SPs.

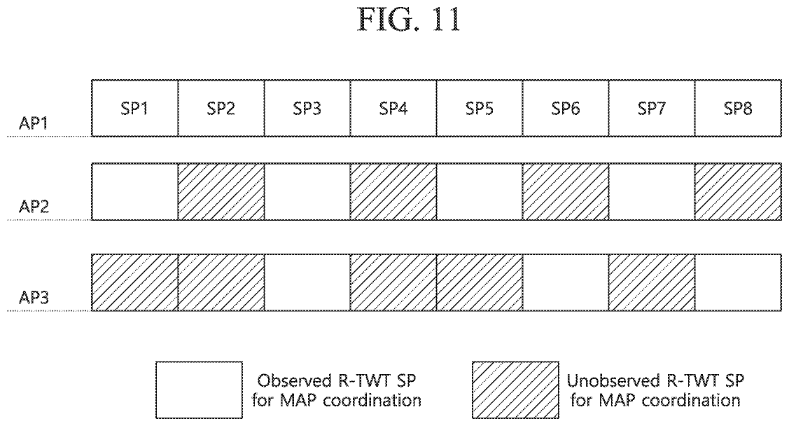

FIG. 11 illustrates an example of observance of R-TWT SPs among multiple neighboring Aps in accordance with an embodiment.

In FIG. 11, AP1, AP2 and AP3 are members of an R-TWT multi-AP coordination set. AP1 may be the R-TWT scheduling AP in AP1's BSS and may be the sharing AP. AP2 and AP3 may be R-TWT shared APs. As illustrated, different APs may comply or observe the R-TWT rules for different R-TWT SP periods and not comply with the R-TWT rules for other R-TWT SP periods. The R-TWT rules can include, for example, a first AP ending a TXOP before the R-TWT SP of a second AP starts, or a rule that a first AP is not allowed to transmit frames during the R-TWT SP of a second AP.

As illustrated in FIG. 11, AP2 may observe or comply with the R-TWT rules for only every other R-TWT SP corresponding to the AP1's R-TWT schedule. AP2 may notify AP1 that it intends to observe or comply with the R-TWT SP rules for only every other R-TWT SP of AP1. Such notification can be sent via a management frame among other types of frames. Likewise, AP3 may observe or comply with the R-TWT rules and not observe or comply with the R-TWT rules for different R-TWT SPs corresponding to the AP1's R-TWT schedule. In particular, for the R-TWT SP of AP1, SP1, SP2, SP4, SP5, SP7 will be unobserved by AP3, and SP3, SP6 and SP8 will be observed by AP3.

In many embodiments, a second AP can advertise a same TWT element that is advertised by a first AP. A timing synchronization function (TSF) value can be different so the Target Wake Time field values in the two TWT element can be different although they may point to the same physical time. In many embodiments, the second AP can modify the TWT element that it advertises in its BSS (e.g. periodicity parameters can change). Also, the second AP can indicate whether the advertised R-TWT schedule corresponds to its own BSS or a neighboring BSS's R-TWT schedule. In many embodiments, the second AP may indicate whether the R-TWT schedule of the AP1 corresponds to UL only or DL only or P2P only or any combination of these traffic flow direction.

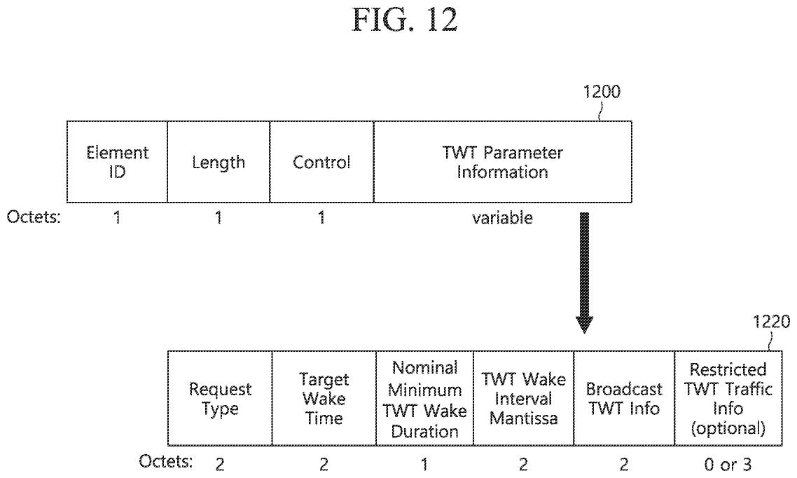

FIG. 12 shows an example of a TWT element 1200 in accordance with an embodiment. The TWT element 1200 may be applicable to IEEE 802.11be standard and any future amendments to the IEEE standard. The TWT element 1200 may be included in a broadcast frame, such as a beacon frame, an association response frame, a reassociation response frame, or a probe response frame, transmitted by Aps affiliated with the AP MLD.

In FIG. 12, the TWT element 1200 may include a Broadcast TWT Parameter Set field 1220 which includes a Request Type field. Details about each field and subfields of the TWT element 1200 are further explained below.

In FIG. 12, the TWT element 1200 may include an Element identifier (ID) field, a length field, a Control field, and a TWT Parameter Information field. The Element ID field may include information to identify the TWT element 1200. The Length field may indicate a length of the TWT element 1200. The Control field may include control information.

The TWT Parameter Information field of the TWT element 1200 may include either a single Individual TWT Parameter Set field or one or more Broadcast TWT Parameter Set fields 1220. In some implementations, if the Broadcast subfield of the Negotiation Type subfield in the Control field is 0, the TWT Parameter Information field includes the single Individual TWT Parameter Set field. Otherwise, the TWT Parameter Information field includes one or more Broadcast TWT Parameter Set fields. FIG. 12 describes the broadcast TWT as an example where the TWT Parameter Information field may include a Broadcast TWT Parameter Set fields 1220.

The Broadcast TWT Parameter Set field 1220 may include a Request Type field, a Target Wake Time field, a Nominal Minimum TWT Wake Duration field, a TWT Wake Interval Mantissa field, a Broadcast TWT Info (Information) field, and an optional Restricted TWT traffic Info field. The Request Type field may include information regarding a type of the request. The Target Wake Time field may include an unsigned integer corresponding to a TSF (time synchronization function) time for the TWT scheduled STA to wake up. The Target Wake Time field may indicate the start time of the TWT service period (SP) on the corresponding link. The Nominal Minimum TWT Wake Duration field may indicate the minimum amount of time that the TWT scheduled STA is expected to be awake in order to compete the frame exchanges for the period of TWT wake interval. The TWT wake interval is the average time that the TWT scheduled STA expects to elapse between successive TWT SPs. The TWT Wake Interval Mantissa field may indicate the value of the mantissa of the TWT wake interval value. The Broadcast TWT Info field may include information on the Broadcast TWT. The Restricted TWT Traffic Info field (optional) may include information regarding the restricted TWT traffic.

A reference to an element in the singular is not intended to mean one and only one unless specifically so stated, but rather one or more. For example, “a” module may refer to one or more modules. An element proceeded by “a,” “an,” “the,” or “said” does not, without further constraints, preclude the existence of additional same elements.

Headings and subheadings, if any, are used for convenience only and do not limit the invention. The word exemplary is used to mean serving as an example or illustration. To the extent that the term “include,” “have,” or the like is used, such term is intended to be inclusive in a manner similar to the term “comprise” as “comprise” is interpreted when employed as a transitional word in a claim. Relational terms such as first and second and the like may be used to distinguish one entity or action from another without necessarily requiring or implying any actual such relationship or order between such entities or actions.

Phrases such as an aspect, the aspect, another aspect, some aspects, one or more aspects, an implementation, the implementation, another implementation, some implementations, one or more implementations, an embodiment, the embodiment, another embodiment, some embodiments, one or more embodiments, a configuration, the configuration, another configuration, some configurations, one or more configurations, the subject technology, the disclosure, the present disclosure, other variations thereof and alike are for convenience and do not imply that a disclosure relating to such phrase(s) is essential to the subject technology or that such disclosure applies to all configurations of the subject technology. A disclosure relating to such phrase(s) may apply to all configurations, or one or more configurations. A disclosure relating to such phrase(s) may provide one or more examples. A phrase such as an aspect or some aspects may refer to one or more aspects and vice versa, and this applies similarly to other foregoing phrases.

A phrase “at least one of” preceding a series of items, with the terms “and” or “or” to separate any of the items, modifies the list as a whole, rather than each member of the list. The phrase “at least one of” does not require selection of at least one item; rather, the phrase allows a meaning that includes at least one of any one of the items, and/or at least one of any combination of the items, and/or at least one of each of the items. By way of example, each of the phrases “at least one of A, B, and C” or “at least one of A, B, or C” refers to only A, only B, or only C; any combination of A, B, and C; and/or at least one of each of A, B, and C.

As described herein, any electronic device and/or portion thereof according to any example embodiment may include, be included in, and/or be implemented by one or more processors and/or a combination of processors. A processor is circuitry performing processing.

Processors can include processing circuitry, the processing circuitry may more particularly include, but is not limited to, a Central Processing Unit (CPU), an MPU, a System on Chip (SoC), an Integrated Circuit (IC) an Arithmetic Logic Unit (ALU), a Graphics Processing Unit (GPU), an Application Processor (AP), a Digital Signal Processor (DSP), a microcomputer, a Field Programmable Gate Array (FPGA) and programmable logic unit, a microprocessor, an Application Specific Integrated Circuit (ASIC), a neural Network Processing Unit (NPU), an Electronic Control Unit (ECU), an Image Signal Processor (ISP), and the like. In some example embodiments, the processing circuitry may include: a non-transitory computer readable storage device (e.g., memory) storing a program of instructions, such as a DRAM device; and a processor (e.g., a CPU) configured to execute a program of instructions to implement functions and/or methods performed by all or some of any apparatus, system, module, unit, controller, circuit, architecture, and/or portions thereof according to any example embodiment and/or any portion of any example embodiment. Instructions can be stored in a memory and/or divided among multiple memories.

Different processors can perform different functions and/or portions of functions. For example, a processor 1 can perform functions A and B and a processor 2 can perform a function C, or a processor 1 can perform part of a function A while a processor 2 can perform a remainder of function A, and perform functions B and C. Different processors can be dynamically configured to perform different processes. For example, at a first time, a processor 1 can perform a function A and at a second time, a processor 2 can perform the function A. Processors can be located on different processing circuitry (e.g., client-side processors and server-side processors, device-side processors and cloud-computing processors, among others).

It is understood that the specific order or hierarchy of steps, operations, or processes disclosed is an illustration of exemplary approaches. Unless explicitly stated otherwise, it is understood that the specific order or hierarchy of steps, operations, or processes may be performed in different order. Some of the steps, operations, or processes may be performed simultaneously or may be performed as a part of one or more other steps, operations, or processes. The accompanying method claims, if any, present elements of the various steps, operations or processes in a sample order, and are not meant to be limited to the specific order or hierarchy presented. These may be performed in serial, linearly, in parallel or in different order. It should be understood that the described instructions, operations, and systems can generally be integrated together in a single software/hardware product or packaged into multiple software/hardware products.

The disclosure is provided to enable any person skilled in the art to practice the various aspects described herein. In some instances, well-known structures and components are shown in block diagram form in order to avoid obscuring the concepts of the subject technology. The disclosure provides various examples of the subject technology, and the subject technology is not limited to these examples. Various modifications to these aspects will be readily apparent to those skilled in the art, and the principles described herein may be applied to other aspects.

All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112, sixth paragraph, unless the element is expressly recited using a phrase means for or, in the case of a method claim, the element is recited using the phrase step for.

The title, background, brief description of the drawings, abstract, and drawings are hereby incorporated into the disclosure and are provided as illustrative examples of the disclosure, not as restrictive descriptions. It is submitted with the understanding that they will not be used to limit the scope or meaning of the claims. In addition, in the detailed description, it can be seen that the description provides illustrative examples and the various features are grouped together in various implementations for the purpose of streamlining the disclosure. This method of disclosure is not to be interpreted as reflecting an intention that the claimed subject matter requires more features than are expressly recited in each claim. Rather, as the following claims reflect, inventive subject matter lies in less than all features of a single disclosed configuration or operation. The following claims are hereby incorporated into the detailed description, with each claim standing on its own as a separately claimed subject matter.

The claims are not intended to be limited to the aspects described herein, but are to be accorded the full scope consistent with the language claims and to encompass all legal equivalents. Notwithstanding, none of the claims are intended to embrace subject matter that fails to satisfy the requirements of the applicable patent law, nor should they be interpreted in such a way.

What is claimed is:

1. A first access point (AP) in a wireless network, the first AP comprising:
a memory;
a processor coupled to the memory, the processor configured to:
receive information related to a target wake time (TWT) schedule and operating channel information from a second AP, wherein the TWT schedule is established on a second channel by the second AP in a second basic service set (BSS); and
transmit, during a TWT service period (SP) of the TWT schedule, data on a first channel in a first BSS, wherein the first channel and the second channel are different.

2. The first AP device of claim 1, wherein the processor is further configured to select the first channel to transmit data based on the operating channel information.

3. The first AP device of claim 1, wherein the operating channel information indicates the first channel as an operating channel that the first AP is allowed to use to transmit data during the TWT SP of the TWT schedule.

4. The first AP device of claim 1, wherein the processor is configured to:
continue a transmit opportunity (TXOP) established in the first BSS during the TWT SP of the TWT schedule.

5. The first AP device of claim 1, wherein the second channel is a primary channel and the first channel is a secondary channel.

6. The first AP device of claim 1, wherein the first AP ensures that a first transmit opportunity (TXOP) ends in the first BSS before a start time of a first TWT SP of the TWT schedule and ensures that a second TXOP continues in the first BSS during a second TWT SP of the TWT schedule.

7. The first AP device of claim 1, wherein the processor is configured to transmit a frame to the second AP that notifies the second AP that the first AP intends to end a transmit opportunity (TXOP) in the first BSS before a start time of a TWT SP of the TWT schedule for a first set of TWT SPs of the TWT schedule and the first AP intends to continue a TXOP for a second set of TWT SPs of the TWT schedule.

8. The first AP device of claim 1, wherein the first AP and the second AP are members of a TWT coordinating multi-AP set.

9. The first AP device of claim 1, wherein the processor is configured to negotiate with the second AP to participate in TWT multi-AP coordination, wherein the first AP is a shared AP and the second AP is a sharing AP.

10. A first access point (AP) in a wireless network, the first AP comprising:
a memory;
a processor coupled to the memory, the processor configured to:
transmit information related to a target wake time (TWT) schedule and operating channel information to a second AP, wherein the TWT schedule is established on a first channel by the first AP in a first basic service set (BSS); and
transmit, during a TWT service period (SP) of the TWT schedule, data on the first channel in the first BSS, wherein the second AP transmits data on a second channel during the TWT SP of the TWT schedule.

11. The first AP device of claim 10, wherein the operating channel information indicates the second channel as an operating channel that the second AP is allowed to use to transmit data during the TWT SP of the TWT schedule.

12. The first AP device of claim 10, wherein the first channel is a primary channel and the second channel is a secondary channel.

13. The first AP device of claim 10, wherein the first AP and the second AP are members of a TWT coordinating AP set.

14. The first AP device of claim 10, wherein the processor is configured to negotiate with the second AP for TWT multi-AP coordination, wherein the first AP is a sharing AP and the second AP is a shared AP.

15. A computer-implemented method for facilitating communication in a wireless network, the method comprising:
receiving information related to a target wake time (TWT) schedule and operating channel information from a second AP, wherein the TWT schedule is established on a second channel by the second AP in a second basic service set (BSS); and
transmitting, during a TWT service period (SP) of the TWT schedule, data on a first channel in a first BSS, wherein the first channel and the second channel are different.

16. The computer-implemented method of claim 15, further comprising selecting the first channel to transmit data based on the operating channel information.

17. The computer-implemented method of claim 15, wherein the operating channel information indicates the first channel as an operating channel that the first AP is allowed to use to transmit data during the TWT SP of the TWT schedule.

18. The computer-implemented method of claim 15, further comprising continuing a transmit opportunity (TXOP) established in the first BSS during the TWT SP of the TWT schedule.

19. The computer-implemented method of claim 15, wherein the second channel is a primary channel and the first channel is a secondary channel.

20. The computer-implemented method of claim 15, wherein the first AP ensures that a first transmit opportunity (TXOP) ends in the first BSS before a start time of a first TWT SP of the TWT schedule and ensures that a second TXOP continues in the first BSS during a second TWT SP of the TWT schedule.
